(19) United States
(12) Patent Application Publication
(10) Pub. No.: US 2019/0084818 A1
(43) Pub. Date: Mar. 21, 2019

(54) FORCE SENSING CARRIAGE FOR LOAD CARRYING VEHICLE

(71) Applicant: Loron, Inc., Kelso, WA (US)

(72) Inventor: Daniel F. Chase, Longview, WA (US)

(73) Assignee: Loron, Inc., Kelso, WA (US)

(21) Appl. No.: 16/131,953

(22) Filed: Sep. 14, 2018

Related U.S. Application Data
(60) Provisional application No. 62/559,424, filed on Sep. 15, 2017.

(51) Int. Cl. B66F 17/00; B60Q 9/00; B66F 9/075; B60Q 5/00; G01L 19/08; G01L 19/12

(52) U.S. Cl. CPC B66F 17/003; B60Q 9/00; G01L 19/12; B60Q 5/005; G01L 19/083; B66F 9/075

(57) ABSTRACT

A force sensing carriage for a load carrying vehicle with lift capability has a first carriage component, a second carriage component and at least one bladder filled with a fluid at a predetermined pressure positioned between the second carriage component and the first carriage component. The first carriage component is configured for mounting to the load carrying vehicle. The second carriage component is for contacting a load to be moved and is positionable in alignment with the first carriage component. The bladder at least partially supports the second carriage component in an operating position in which a portion of the second carriage component is spaced away from the first carriage component. Forces exerted on the bladder by the second carriage component increase pressure in the bladder. An indicator circuit with an indicator indicates a warning if a predetermined threshold pressure is exceeded.

### CROSS REFERENCE TO RELATED APPLICATION

This application claims the benefit of U.S. Provisional Patent Application No. 62/559,424, filed Sep. 15, 2017, which is hereby incorporated by reference.

### BACKGROUND

This application relates to load carrying vehicles, and more specifically to a carriage for a load carrying vehicle that provides a physical interface between the load to be moved and the vehicle.

When lifting and placing a load with a load carrying vehicle, such as, e.g., a lift truck, damage to the products making up the load can occur from pushing the load with too much force or allowing the load to impact an object with too much force (e.g., the floor, the ground, another load that is stationary, or any other object). One load lifting and carrying application of particular interest is so-called “high bulk, low density” loads in which the cartons or other packaging have relatively high volumes but relatively low weights. Cartons holding household appliances are one example of high bulk, low density loads. One current approach to handling appliance cartons is to use a Basiloid Lift-A-Pliance attachment that replaces the forks of a lift truck. The attachment has lifting blades (or spades) that are inserted into pockets formed at the tops of cartons to lift the cartons from their tops rather than sliding forks under the cartons.

In typical use of such attachments, however, damage to cartons and their contents still occurs. As one example, when operators push cartons with too much force, such as when they are attempting to load cartons into trailers, damage can result. Other actions in manipulating cartons can also create too much force on cartons and cause risk to their contents.

### SUMMARY

Described below is a force sensing carriage for a load carrying vehicle that addresses some of the drawbacks of current load carrying and lifting attachments. The force sensing carriage is configured to sense, simply and reliably, when the force applied to a carton exceeds a predetermined safe force, and if so, to warn the operator and/or take other steps (e.g., to control the vehicle and/or log the event). In addition, the force sensing carriage can have a lifting mode that disables operation of the force sensing mode.

In a first implementation, a force sensing carriage for a load carrying vehicle with lift capability has a first carriage component, a second carriage component and at least one bladder filled with a fluid at a predetermined pressure positioned between the second carriage component and the first carriage component. The first carriage component is configured for mounting in an upright position to the load carrying vehicle. The second carriage component is for contacting a load to be moved with the load carrying vehicle, the second carriage component being positionable in an upright position and in alignment with the first carriage component.

The at least one bladder at least partially supports the second carriage component in an operating position in which a portion of the second carriage component is spaced away from the first carriage component. A current pressure in the bladder is influenced by forces exerted on the bladder by the second carriage component (which would include the load and other forces). An indicator circuit is linked to the bladder and includes an indicator (warning device). The indicator is configured to indicate a warning to an operator of the load carrying vehicle if the current pressure exceeds a predetermined threshold pressure.

In some implementations, an upper end of the second carriage component is coupled to an upper end of the first carriage component such that the second carriage component is suspended from the first carriage component. The upper end of the second carriage component can be coupled to pivot and to translate relative to an upper end of the first carriage.

In some implementations, the indicator circuit comprises a pressure switch configured to sense the current pressure in the bladder and to trigger operation of the indicator if the threshold pressure is reached.

In some implementations, the second carriage component is U-shaped and comprises first and second upright side members and a lateral member that joins the first and second upright side members together. The first and second upright members of the second carriage component can have respective lower ends that each coupled to the first carriage member to restrict motion of the second carriage component in an upward direction and/or an outward direction beyond a predetermined position.

The one or more bladders can comprise a first side bladder adjacent the first upright side member, a second side bladder adjacent the second upright side member and an intermediate bladder adjacent the lateral member. The bladders can be fluidicly interconnected. There can be a fill valve for adjusting a current pressure in the first side bladder, the second side bladder and the intermediate bladder.

In some implementations, there is a first intermediate member bladder positioned on a first side of a midplane of the carriage, and a second intermediate bladder positioned on a second side of the midplane opposite the first side.

The threshold pressure can be set to protect the contents of high density, low bulk carton loads contacted by the second carriage member.

The indicator or warning device can comprise at least one of a visual indicator or an audio indicator. The carriage can have a battery or other supply of power for operating the indicator or warning device.

In another implementation, the second carriage component can be movable relative to the first carriage component along an upright axis defined by the upright position of the first carriage component. The indicator circuit (force sensing mode) is configured to be deactivated when the second carriage component is subjected to a force having a vertical component exceeding a vertical force threshold.

In another implementation, the second carriage component can be configured to move laterally (i.e., aft) into contact against the first carriage component and move vertically downward relative to the first carriage component into a lock out position when the second carriage component is subjected to a force having a vertical component exceeding a vertical force threshold. In the lock out position, the second carriage component is restricted from tilting relative to the first carriage component, thereby deactivating the indicator circuit and permitting the carriage to be used to lift heavy loads vertically without triggering the indicator.

The first and second carriage components comprise can rollers to assist the second carriage component in moving relative to the first carriage component.

In another implementation, the first carriage component has first rollers mounted at a first elevation, the second carriage component has second rollers mounted at a second elevation above the first elevation, and the second carriage component has first roller openings positioned at the first elevation when the vertical loading on the second carriage component is below a predetermined minimum vertical loading. When the first rollers and first roller openings are aligned such that the first rollers are engaged in the first roller openings, then the second carriage component can tilt relative to the first carriage component. When the vertical loading on the second carriage component exceeds the predetermined minimum vertical loading, then the second carriage component moves downwardly relative to the first carriage component, disengaging the first roller openings from the first rollers and thereby locking out the second carriage component from tilting relative to the first carriage component. There can be springs mounted between the first and second carriage components to urge the first roller openings of the second carriage component upwardly and into alignment with the first rollers at the first elevation.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exploded perspective view of a force sensing carriage according to a first implementation, showing a forward side of the carriage components.

FIG. 2 is an exploded perspective view of the force sensing carriage of FIG. 1, showing a rear side of the carriage components.

FIG. 3 is a section view of an upper end of a second carriage component.

FIG. 4 is a perspective view of a force sensing carriage according to a second implementation.

FIG. 5 is an exploded perspective view of the force sensing carriage of FIG. 4.

FIGS. 6 and 7 are schematic side elevation and top plan views, respectively, of a load carrying vehicle to which a force sensing carriage has been coupled for use.

FIG. 8 is a flow chart of a representative method of the force sensing carriage.

FIG. 9 is a schematic block diagram of a representative control circuit according to one implementation.

### DETAILED DESCRIPTION

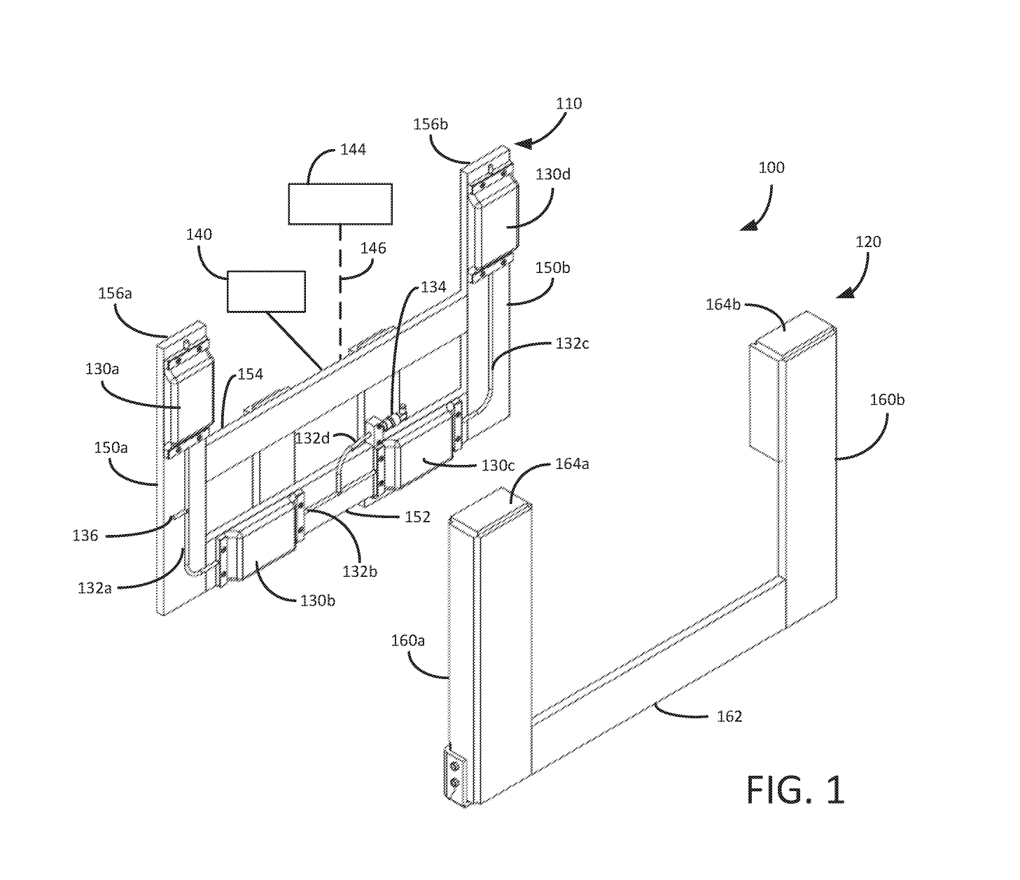

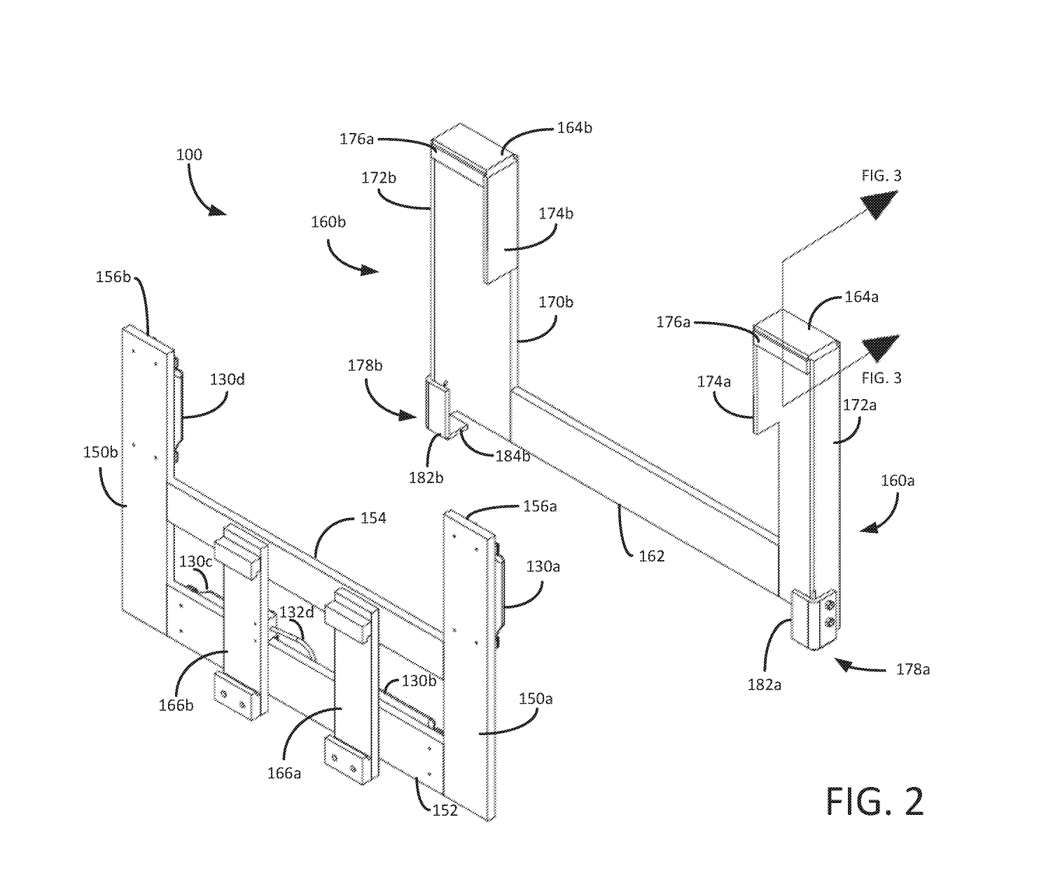

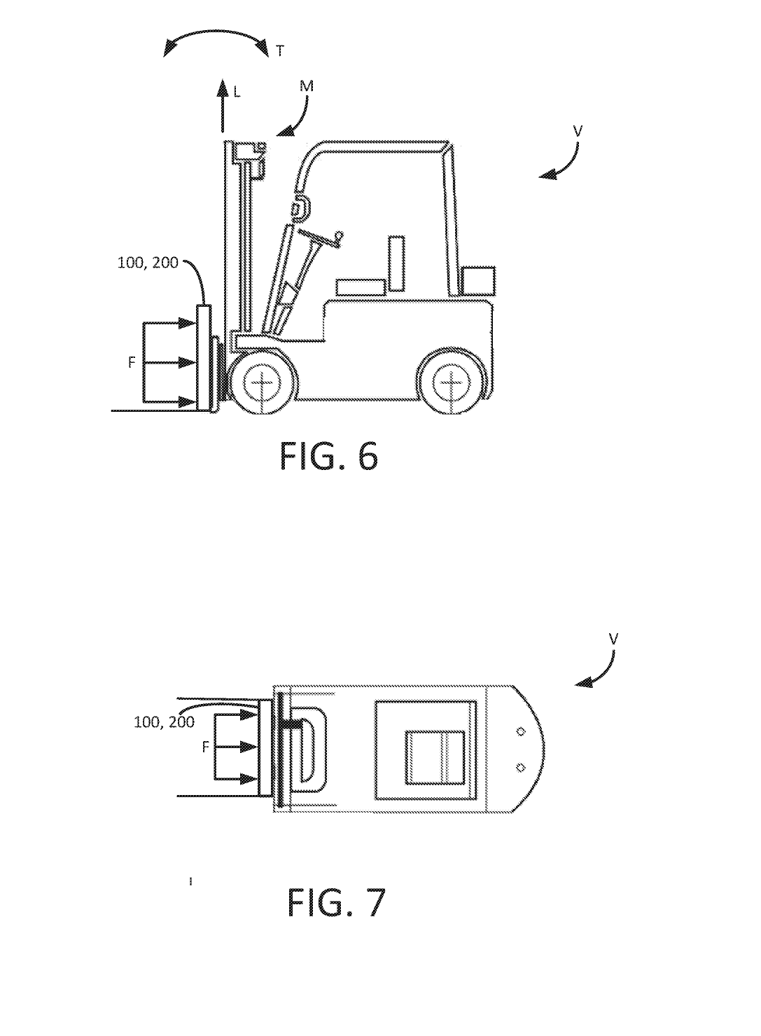

FIG. 1 is an exploded perspective view of a force sensing carriage 100 for a load carrying vehicle (such as a representative vehicle V shown in FIGS. 6 and 7) according to a first implementation. FIG. 1 shows a first carriage component 110 and a corresponding second carriage component 120 from their forward sides, and FIG. 2 is another exploded perspective view showing the carriage components from their reverse sides. As is described in further detail below, the second carriage component 120 is supported by, but movable relative to, the first carriage component 110.

As shown, there are one or more bladders, such as the bladders 130a, 130b, 130c and 130d positioned between the first carriage component 110 and the second carriage component 120 such that the second carriage component 120 contacts one or more of the bladders 130a, 130b, 130c, 130d, and, during use, transmits force exerted on the second carriage component 120 to the bladders. Some of the force transmitted to the bladders will be absorbed by them, as is discussed below in greater detail, and any excess force is transmitted to the first carriage component 120 and rest of the vehicle V.

In the illustrated implementation, the four bladders 130a, 130b, 130c and 130d are at least partially filled with a fluid and are interconnected as shown by hose or tubing segments 132a, 132b, 132c. A hose or tubing segment 132d leads to a pressure switch or pressure transducer 134. One suitable pressure switch is the ProSense Model MPS25-1C-DV15D mechanical pressure switch. In some implementations, the bladders are initially filled with air or other gas to a selected pressure when they are in their at rest state using a fill valve 136. In some implementations, the selected initial pressure is about 4 psi, but the selected initial pressure can of be adjusted according to specific operating requirements and the geometry of the carriage, among other factors.

The pressure switch 134 is connected to an indicator or warning device 140, such as an audio and/or visual warning device (e.g., an alarm and/or light). The pressure switch 134 is configured to cause the warning device 140 to operate when a pressure in the bladders exceeds a predetermined threshold pressure. If the threshold pressure in the indicator circuit is exceeded, then the warning device 140 warns the vehicle operator so the operator can take action to reduce the force on the second carriage component 120 (and in turn reduce the pressure sensed by the bladders and communicated to the pressure switch 134).

Optionally, there may also be a control element 144 linked to the carriage 100 by a wireless or wired connection 146. The optional control element 144, which may be on the vehicle V or on the carriage, may be configured to interact with the vehicle or other systems when a threshold pressure is reached. For example, the control element 144 could be configured to shut down operation of the vehicle, to reduce vehicle speed, to log an event and/or take other action automatically upon experiencing a threshold pressure condition.

In the illustrated implementation, the first carriage component 110 has a framework that includes upright members 150a, 150b, a lower lateral member 152 and an upper lateral member 154. The upright member 150a has an upper end 156a, and the upright member 150b has an upper end 156b. The upright members 150a, 150b and the lateral members 152, 154 can be plate-like members made of metal as shown, or can have any other suitable configuration. In the illustrated implementation, the bladders are connected to the upright members 150a, 150b and the lower lateral member 152 in the positions shown with fasteners.

The second carriage component 120 has a configuration that complements the first carriage component 110 so that they can interact with each other. The second carriage component 110 in the illustrated implementation has upright members 160a, 160b that are joined by a lateral member 162. The upright members 160a, 160b can have respective coupling areas 164a, 164b that are sized to allow the second carriage component 120 to be coupled to the first carriage component 110. More specifically, the second coupling areas 164a, 164b can be configured to fit over the respective upper ends 156a, 156b of the first carriage component 110 to at least partially suspend the second carriage component 120 from the first carriage component 110. The bladder 130a contacts the upright member 160a. The bladders 130b, 130c contact the lateral member 162. The bladder 130d contacts the upright member 160b.

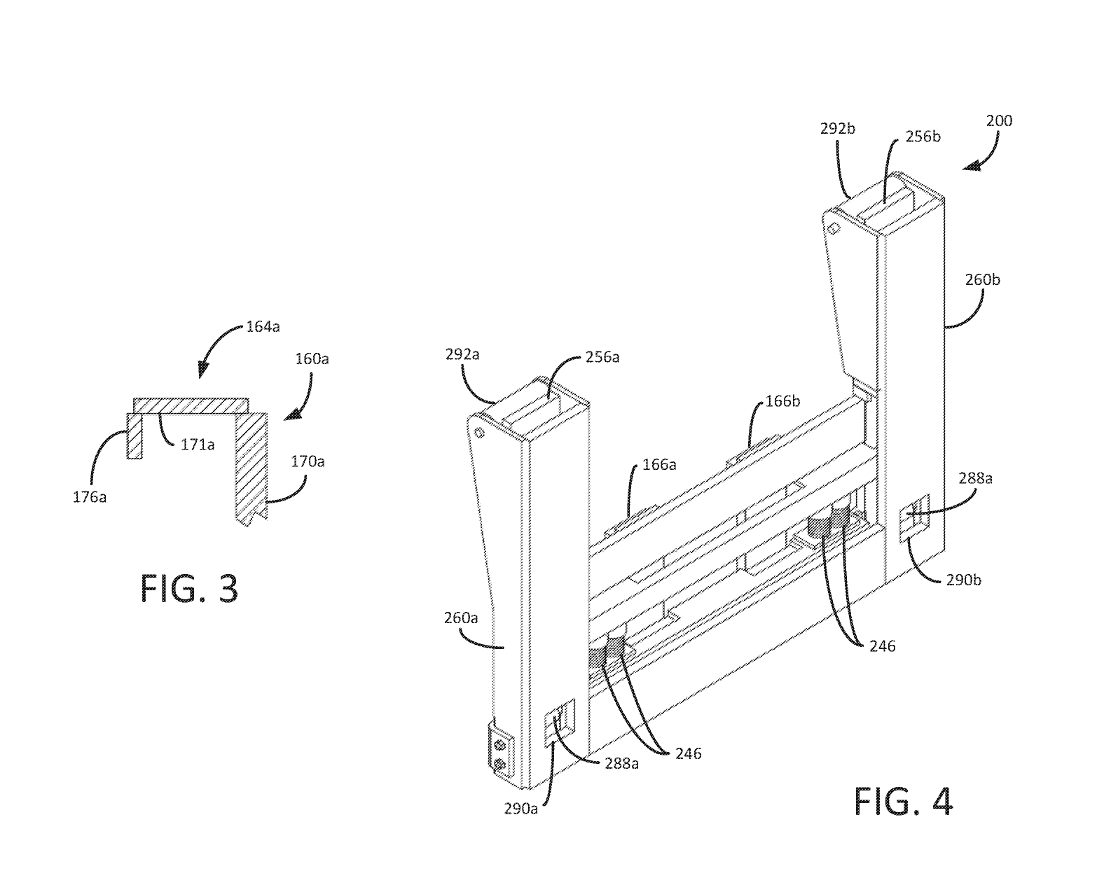

As best shown in FIGS. 2 and 3, the coupling areas 164a, 164b have a greater dimension than the ends 156a, 156b. Thus, the coupling areas 164a, 164b are sized large enough to allow (1) for some movement of the second carriage component 120 horizontally in a fore/aft direction relative to the first carriage component, (2) for movement of the lower end of the second carriage component, such as a pivoting or tilting motion of the lower end in the vertical plane relative to the upper end and/or the first carriage component, and (3) for some degree of twisting motion of the second carriage component to the left or to the right relative to the first carriage component.

FIG. 3 is a cross section view showing the coupling area 164a in greater detail. The coupling area 164a has an upper side 171a that contacts the upper end 156a, and a forward side 170a and a rearward side 176a that constrain the range of motion in the fore/aft direction. It is predominately the upper side 171a by which the second carriage member 120 is suspended or “hangs off of” the first carriage member. Referring to FIG. 2, the coupling area 164a also has an outer side 172a and an opposite inner side 174a that constrain the range of motion in the horizontal direction. At a lower end, the second carriage component has lower retainer members 178a, 178b that have respective projecting rear sides 182a, 182b and lower sides 184a, 184b that fit around respective lower ends of the first carriage component 110 to constrain its motion relative to the first carriage component.

As also shown in FIG. 2, the carriage 100 can be configured for coupling to a standard load carrying vehicle, such as a lift truck or other similar vehicle, using carriage coupling members 166a, 166b or another similar arrangement.

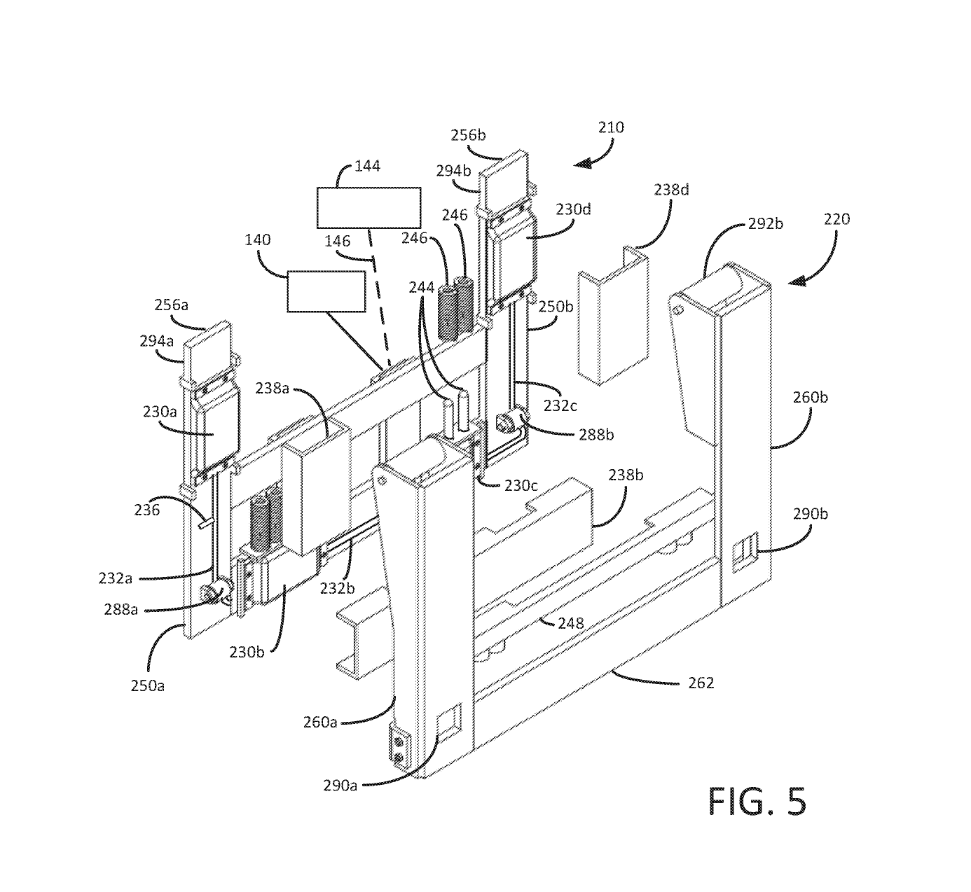

FIGS. 4 and 5 are perspective views of a carriage 200 according to a second implementation configured to allow for force sensing but also to allow for lifting of loads without any undesired tilting caused by the carriage. In FIGS. 4 and 5, the same reference numerals plus 100 are used for components described above and no additional is repeated here.

With the carriage 200 in a mode as shown in FIG. 4, force sensing operation is enabled, similar to operation of the carriage 100. In particular, the carriage 200 is provided with rollers 288a, 288b that project from the first carriage member 210 and are engaged in respective openings 290a, 290b formed in the second carriage member 220 in the force sensing mode. Instead of the coupling areas 164a, 165a at the upper ends, there are upper rollers 292a, 292b that engage the rear sides of uprights 250a, 250b, respectively. As a result, the second carriage member 220 is supported relative to the first carriage member 210 by the engagement between the rollers 288a, 288b and the openings 290a, 290b such that the second carriage member 220 is free to tilt or pivot about these locations relative to the first carriage member 210. Any such pivoting or tilting motion is then sensed by the bladders 230a, 230b, 230c and 230d. If the second carriage component 120 and load are subjected to too much force, then the sensed pressure exceeds the threshold pressure and a warning signal to the operator is triggered by the warning device 140.

In a second mode, force sensing operation is disabled. The second mode of operation is triggered when the operator initiates a lifting operation of a predetermined load. The predetermined load may be set as low as 100-200 pounds. Such disabling or “locking out” of the force sensing mode may be preferred in situations where permitting any slight tilt of the second carriage component 220 relative to a lifting axis L (see FIG. 6) would be undesirable. Although an operator might be able to compensate for such slight tilting in the second carriage component (such as by tilting the mast M in the opposite direction), not all vehicles may be so equipped. In addition, disabling tilt during lifting may be safer and more efficient.

Referring to FIGS. 4 and 5, there are one or more springs 246 (or other similar elements) attached to spring mounts 244 connected to the first carriage component 210 and configured to support the second carriage component vertically relative to first carriage component up to a predetermined load. When the operator attempts to lift a load in excess of the predetermined load, the first carriage component 210 moves upward while the second carriage component remains at the same height, thereby causing the springs 246 to compress and the rollers 288a, 288b to become disengaged from the openings 290a, 290b, as the upper ends 256a, 256b move upward past the rollers 292a, 292b. In this way, the second carriage component 220 becomes “locked out” and cannot tilt relative to the first carriage component 120.

The bladders can be provided with cover members 238a, 238b and 238d as shown. The springs 246 are preferably fitted with a cover member 248.

In some implementations, the bladders can be filled with a liquid, such as water, instead of air. In such implementations, it may be advantageous to provide for shock absorption, which is an additional feature of air-filled bladders in at least some conditions. Liquid-filled bladders may compress less and therefore may allow more lifting without excess tilting in some conditions.

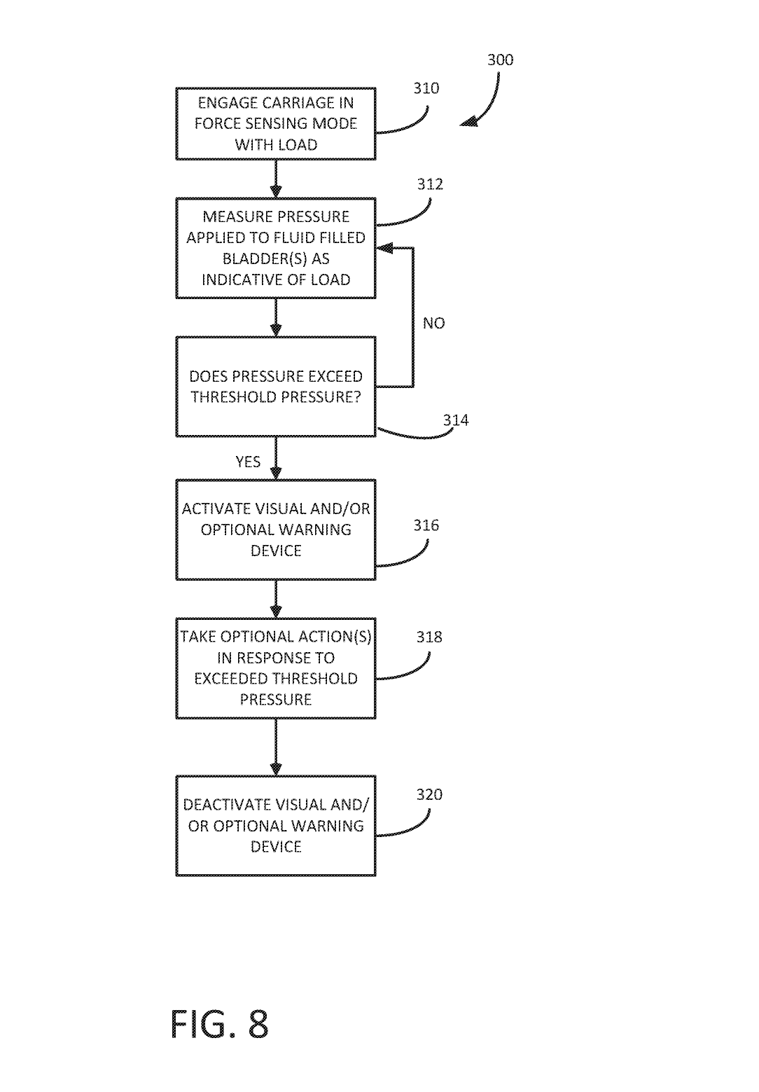

FIG. 8 is a flow chart of a representative method 300 of operating a carriage equipped with force sensing. In step 310, the carriage 100, 200 is configured in a force sensing mode and engaged with a load. In step 312, the pressure applied to the fluid filled bladder(s), e.g., 130a, 130b, 130c and/or 130d, which is indicative of the load, is measured, such as by using the pressure transducer 134 or another similar device. In step 314, it is determined whether the threshold pressure is exceeded. If not, then operation continues with possible additional measurements of pressure in the bladder because the load may increase as subsequent motions to move the load are made.

If it is determined that the threshold pressure is exceeded, then in optional step 316 one or more indicators or warning devices 140 are actuated. The warnings can be directed to informing the operator of the condition of the load. The operator can then take action to correct the condition.

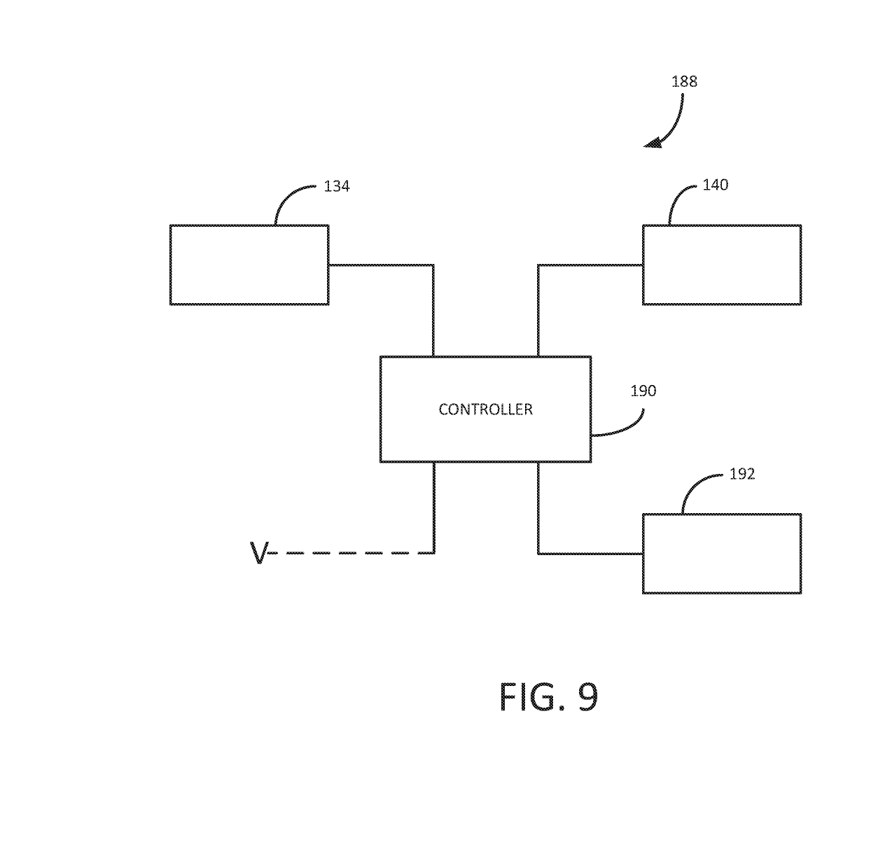

In step 318, one or more other optional actions can also be taken if the threshold pressure is exceeded. For example, the exceeded threshold pressure can be configured to cause operation of the vehicle to shut down, to cause the vehicle speed to be reduced and/or to cause an event to be logged and stored in memory (such as memory a memory 192 shown in FIG. 9 and described below). Other similar actions are also possible.

In step 320, the indicator or warning device 140 is deactivated. The system can be configured to deactivate the warning device 140 after the pressure decreases below the threshold pressure, after a predetermined time interval or in response to another condition. In addition, the force sensing mode can be deactivated as described above, such as when the operator initiates a lifting operation of a predetermined load.

FIG. 9 is a schematic block diagram of a representative control circuit 188 according to one implementation. In the control circuit 188, there is a control element, such as a controller 190 that is interconnected with the pressure transducer 134, the warning device(s) 140 and, optionally, the vehicle V and the memory 192. In response to signals received from the pressure transducer 134, the controller 190 sends a signal to activate or terminate activation of the warning device(s) 140. The controller 190 can also cause data, such as a log file of activity data, to be written to the memory 192, and/or to retrieve data from the memory 192.

The controller 190 may also may be configured to interact with the vehicle V or other systems, such as when a threshold pressure is reached (for example, to shut down operation of the vehicle, to reduce vehicle speed, to log an event and/or take other action automatically) and/or upon occurrence of other predetermined conditions.

The controller 190 can be a microcontroller. The memory 192 can be, e.g., a SD card reader and SD card or other similar memory device. The control circuit 188 can be connected to a source of power, such as a battery for the vehicle V or a dedicated battery for the control circuit 188.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A force sensing carriage for a load carrying vehicle with lift capability, comprising:
a first carriage component configured for mounting in an upright position to the load carrying vehicle;
a second carriage component for contacting a load to be moved with the load carrying vehicle, the second carriage component being positionable in an upright position and in alignment with the first carriage component;
at least one bladder filled with a fluid at a predetermined pressure and positioned between the second carriage component and the first carriage component, wherein the bladder at least partially supports the second carriage component in an operating position in which a portion of the second carriage component is spaced away from the first carriage component, and wherein a current pressure in the bladder is influenced by forces exerted on the bladder by the second carriage component; and
an indicator circuit linked to the bladder and comprising an indicator, wherein the indicator is configured to indicate a warning to an operator of the load carrying vehicle if the current pressure exceeds a predetermined threshold pressure.

2. The force sensing carriage of claim 1, wherein an upper end of the second carriage component is coupled to an upper end of the first carriage component such that the second carriage component is suspended from the first carriage component.

3. The force sensing carriage of claim 2, wherein the upper end of the second carriage component is coupled to pivot and to translate relative to an upper end of the first carriage.

4. The force sensing carriage of claim 1, wherein the indicator circuit comprises a pressure switch configured to sense the current pressure in the bladder and to trigger operation of the indicator if the threshold pressure is reached.

5. The force sensing carriage of claim 1, wherein the second carriage component is U-shaped and comprises first and second upright side members and a lateral member that joins the first and second upright side members together.

6. The force sensing carriage of claim 5, wherein the first and second upright members of the second carriage component have respective lower ends that each coupled to the first carriage member to restrict motion of the second carriage component in an upward direction and/or an outward direction beyond a predetermined position.

7. The force sensing carriage of claim 5, wherein the at least one bladder comprises a first side bladder adjacent the first upright side member, a second side bladder adjacent the second upright side member and an intermediate bladder adjacent the lateral member, and wherein the bladders are fluidicly interconnected.

8. The force sensing carriage of claim 7, further comprising a fill valve for adjusting a current pressure in the first side bladder, the second side bladder and the intermediate bladder.

9. The force sensing carriage of claim 7, wherein the intermediate bladder is a first intermediate bladder positioned on a first side of a midplane of the carriage, further comprising a second intermediate bladder positioned on a second side of the midplane opposite the first side.

10. The force sensing carriage of claim 1, wherein the threshold pressure is set to protect the contents of high density, low bulk carton loads contacted by the second carriage member.

11. The force sensing carriage of claim 1, wherein the indicator comprises at least one of a visual indicator or an audio indicator.

12. The force sensing carriage of claim 1, wherein the second carriage component is movable relative to the first carriage component along an upright axis defined by the upright position of the first carriage component.

13. The force sensing carriage of claim 1, wherein the indicator circuit is configured to be deactivated when the second carriage component is subjected to a force having a vertical component exceeding a vertical force threshold.

14. The force sensing carriage of claim 1, wherein second carriage component is configured to move laterally into contact against the first carriage component and move vertically downward relative to the first carriage component into a lock out position when the second carriage component is subjected to a force having a vertical component exceeding a vertical force threshold,
wherein in the lock out position, the second carriage component is restricted from tilting relative to the first carriage component, thereby deactivating the indicator circuit and permitting the carriage to be used to lift heavy loads vertically without triggering the indicator.

15. The force sensing carriage of claim 14, wherein the first and second carriage components comprise rollers to assist the second carriage component in moving relative to the first carriage component.

16. The force sensing carriage of claim 14, wherein the first carriage component has first rollers mounted at a first elevation, the second carriage component has second rollers mounted at a second elevation above the first elevation, and the second carriage component has first roller openings positioned at the first elevation when the vertical loading on the second carriage component is below a predetermined minimum vertical loading,
wherein when the first rollers and first roller openings are aligned such that the first rollers are engaged in the first roller openings, then the second carriage component can tilt relative to the first carriage component, and
wherein when the vertical loading on the second carriage component exceeds the predetermined minimum vertical loading, then the second carriage component moves downwardly relative to the first carriage component, disengaging the first roller openings from the first rollers and thereby locking out the second carriage component from tilting relative to the first carriage component.

17. The force sensing carriage of claim 16, further comprising springs mounted between the first and second carriage components to urge the first roller openings of the second carriage component upwardly and into alignment with the first rollers at the first elevation.

18. A method of sensing force applied to a carriage for a load carrying vehicle with lift capability, the carriage comprising first and second carriage components with the second component contacting a load to be moved with the load carrying vehicle and at least a portion thereof being spaced away from the first carriage component in an operating position by at least one bladder filled with a fluid at a predetermined initial pressure positioned between the second carriage component and the first carriage component, the method comprising:
detecting a current pressure in the bladder indicative of a load on the second carriage component transmitted to the bladder; and
causing an indicator to indicate a warning if the current pressure exceeds a predetermined threshold pressure.

19. The method of claim 18, wherein an upper end of the second carriage component is coupled to an upper end of the first carriage component such that the second carriage component is suspended from the first carriage component.

20. The method of claim 18, wherein a pressure transducer is fluidicly connected to the bladder, and wherein detecting a current pressure in the bladder comprises detecting the current pressure with the pressure transducer.
